(19) United States
(12) Patent Application Publication
(10) Pub. No.: US 2024/0330715 A1
(43) Pub. Date: Oct. 3, 2024

(54) DIGITAL TWIN BASED DATA DEPENDENCY INTEGRATION IN AMELIORATION MANAGEMENT OF EDGE COMPUTING DEVICES

(71) Applicant: International Business Machines Corporation, Armonk, NY (US)

(72) Inventors: Atul Mene, Morrisville, NC (US); Jeremy R. Fox, Georgetown, TX (US); Tushar Agrawal, West Fargo, ND (US); Sarbajit K. Rakshit, Kolkata (IN)

(21) Appl. No.: 18/194,681

(22) Filed: Apr. 3, 2023

(51) Int. Cl. G06N 5/022

(52) U.S. Cl. CPC G06N 5/022

(57) ABSTRACT

A computer-implemented method, a computer program product, and a computer system for amelioration management of edge computing devices. A computer generates digital twin models of respective ones of edge devices. A computer uses the digital twin models to predict an impacted edge device which has a health issue in edge computing. A computer uses the digital twin models to predict impact occurring time. A computer, based on simulations with the digital twin models, reassign a portion of edge computing loads that originally assigned to the impacted edge device to other edge devices. A computer keeps remaining edge computing loads on the impacted edge device such that the impacted edge device is able to complete the remaining edge computing loads prior to the impact occurring time. A computer removes dependencies of the other edge devices on the impacted edge device, in response to the remaining edge computing loads being completed.

### BACKGROUND

The present invention relates generally to edge computing devices, and more particularly to digital twin based data dependency integration in amelioration management of edge computing devices.

The recent trend of edge computing extends cloud computing and the Internet of Things (IoT) to the edge of the network. Edge computing moves more computational power and resources closer to end users by increasing the number of endpoints and locating them nearer to the consumers. Fundamentally, edge computing architectures are built on existing technologies and established paradigms for distributed systems.

While performing physical activities, edge computing devices can also perform edge computing; for example, a mobile robot can perform a physical activity and also edge computing. Both the physical activity and the edge computing are performed in parallel.

The edge computing devices perform edge computing in a collaborative manner. In this scenario, there may be different types of problems with the collaborative edge computing devices. If any problem (such as a mechanical or electrical problem) occurs during edge computing, entire computation with the collaborative edge computing devices will be impacted. For example, if an impacted edge computing device suddenly stopped working, the other edge computing devices that collaborate with the impacted edge computing device will not be able to continue the edge computing because of linked dependencies.

### SUMMARY

In one aspect, a computer-implemented method for amelioration management of edge computing devices is provided. The computer-implemented method includes generating digital twin models of respective ones of edge devices, based on current states of the respective ones of the edge devices. The computer-implemented method further includes using the digital twin models to predict an impacted edge device which has a health issue in edge computing. The computer-implemented method further includes using the digital twin models to predict impact occurring time. The computer-implemented method further includes, based on simulations with the digital twin models, reassigning a portion of edge computing loads that originally assigned to the impacted edge device to the edge devices other than the impacted edge device. The computer-implemented method further includes keeping remaining edge computing loads on the impacted edge device such that the impacted edge device is able to complete the remaining edge computing loads prior to the impact occurring time. The computer-implemented method further includes removing dependencies of the edge devices other than the impacted edge device on the impacted edge device, in response to the remaining edge computing loads being completed.

In another aspect, a computer program product for amelioration management of edge computing devices is provided. The computer program product comprises a computer readable storage medium having program instructions embodied therewith, and the program instructions are executable by one or more processors. The program instructions are executable to: generate digital twin models of respective ones of edge devices, based on current states of the respective ones of the edge devices; use the digital twin models to predict an impacted edge device which has a health issue in edge computing; use the digital twin models to predict impact occurring time; based on simulations with the digital twin models, reassign a portion of edge computing loads that originally assigned to the impacted edge device to the edge devices other than the impacted edge device; keep remaining edge computing loads on the impacted edge device such that the impacted edge device is able to complete the remaining edge computing loads prior to the impact occurring time; and remove dependencies of the edge devices other than the impacted edge device on the impacted edge device, in response to the remaining edge computing loads being completed.

In yet another aspect, a computer system for amelioration management of edge computing devices is provided. The computer system comprises one or more processors, one or more computer readable tangible storage devices, and program instructions stored on at least one of the one or more computer readable tangible storage devices for execution by at least one of the one or more processors. The program instructions are executable to generate digital twin models of respective ones of edge devices, based on current states of the respective ones of the edge devices. The program instructions are further executable to use the digital twin models to predict an impacted edge device which has a health issue in edge computing. The program instructions are further executable to use the digital twin models to predict impact occurring time. The program instructions are further executable to, based on simulations with the digital twin models, reassign a portion of edge computing loads that originally assigned to the impacted edge device to the edge devices other than the impacted edge device. The program instructions are further executable to keep remaining edge computing loads on the impacted edge device such that the impacted edge device is able to complete the remaining edge computing loads prior to the impact occurring time. The program instructions are further executable to remove dependencies of the edge devices other than the impacted edge device on the impacted edge device, in response to the remaining edge computing loads being completed.

### BRIEF DESCRIPTION OF THE SEVERAL VIEWS OF THE DRAWINGS

FIG. 1 illustrates a system for digital twin based data dependency integration in amelioration management of edge computing devices, in accordance with one embodiment of the present invention.

FIG. 2(A) and FIG. 2(B) present a flowchart showing operational steps of digital twin based data dependency integration in amelioration management of edge computing devices, in accordance with one embodiment of the present invention.

FIG. 3 is a systematic diagram illustrating an example of an environment for the execution of at least some of the computer code involved in performing digital twin based data dependency integration in amelioration management of edge computing devices, in accordance with one embodiment of the present invention.

### DETAILED DESCRIPTION

Embodiments of the present invention disclose digital twin sharing integration with edge computing devices. In an edge computing ecosystem, participating edge computing devices share digital twin models. The digital twin models are used by a proposed system to predict expected duration of healthy status when physical activities are performed in surroundings. The digital twin models are also used to predict any reduction in an edge computing capability of any edge computing device. Accordingly, the edge computing ecosystem will assign edge computing loads to different edge computing devices so that dependency with an impacted edge computing device can be eliminated or reduced.

Embodiments of the present invention disclose digital twins simulations of expansion or contraction of aggregate edge computing devices. Based on the digital twin simulations of the edge computing devices, a proposed system predicts how long different edge computing devices are available to participate in the edge computing. Accordingly, the proposed system assigns appropriate edge computing loads so that assigned edge computing loads can be completed within an availability duration of all the edge computing devices.

In a case where synchronized mobility is required among the edge computing devices during edge computation, when a proposed system in the present invention uses digital twin simulations to predict that one or more edge computing devices will not be able to maintain the synchronized movement, the proposed system will proactively control edge computing loads. Therefore, even if any impacted edge computing device is not able to maintain synchronized movement, other edge computing devices can continue to perform edge computing without keeping the dependency with the impacted edge computing device.

A proposed system in the present invention analyzes digital twin models of edge computing devices to determine whether there is any mechanical or electrical problem with the edge computing devices or any problem with edge computing resources. Accordingly, the proposed system estimates how much edge resources are available and duration of availability, so that the proposed system can proactively transfer or swap edge computing loads among the edge computing devices.

In embodiments of the present invention, based on digital twin simulations of edge computing devices, a proposed system determines when edge computing resources are reduced and replacement of the impacted edge computing devices is required. Accordingly, the proposed system dynamically replace impacted edge computing devices in a timely fashion.

In embodiments of the present invention, based on digital twin simulations of edge computing devices, a proposed system identifies a problem with one or more edge computing devices and further identifies that a defective device is unable to maintain synchronized speed of data transfer or communication while the edge computing is in progress. Through amelioration management by the proposed system, other edge computing devices will collaborate and adjust the speed so that pending edge computing activities can be completed.

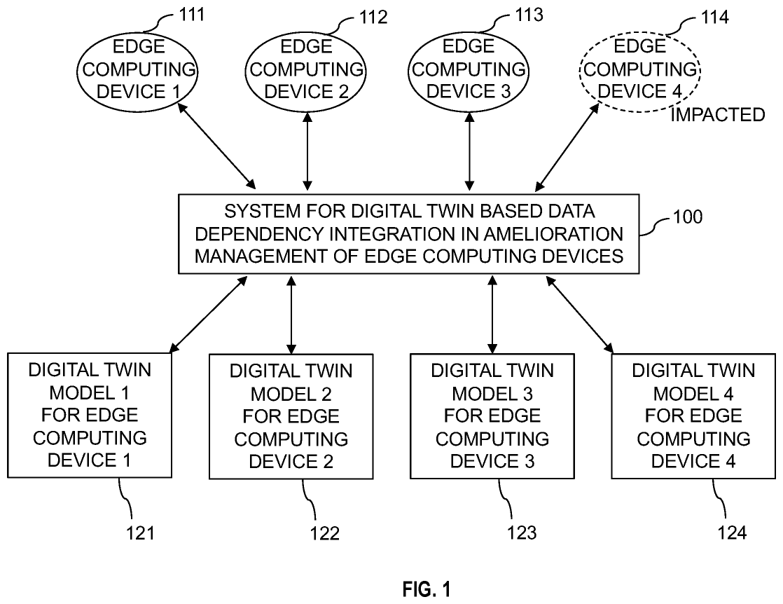

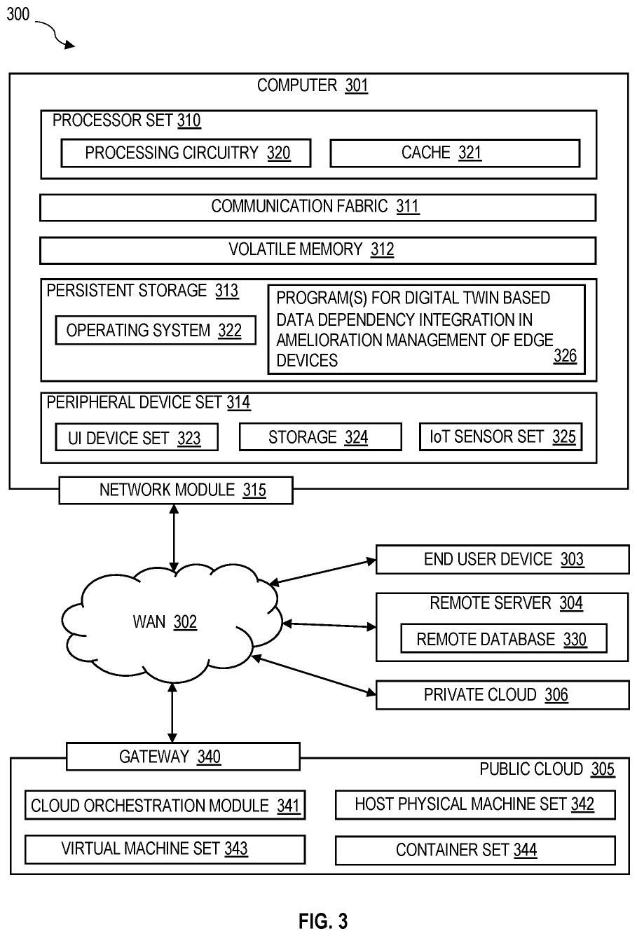

FIG. 1 illustrates system 100 for digital twin based data dependency integration in amelioration management of edge computing devices, in accordance with one embodiment of the present invention. System 100 is situated on a computer or server (such as computer 301 in FIG. 3).

System 100 is responsible for amelioration management of edge computing devices. As shown in FIG. 1, the edge computing devices include edge computing device 1 (111), edge computing device 2 (112), edge computing device 3 (113), and edge computing device 4 (114). The edge computing devices participate in edge computing and/or a physical activity in a collaborative manner. Among the edge computing devices, edge computing device 4 (114) is an impacted edge computing device which may encounter a health issue such as mechanical or electronical problems during performing edge computing and/or a physical activity.

System 100 uses digital twin models predict expected duration of healthy status when edge computing and/or a physical activities are performed in surroundings. In the example shown in FIG. 1, the digital twin models include digital twin model 1 (121) for edge computing device 1 (111), digital twin model 2 (122) for edge computing device 2 (112), digital twin model 3 (123) for edge computing device 3 (113), and digital twin model 4 (124) for edge computing device 4 (114).

System 100 predicts how long edge computing device 1 (111), edge computing device 2 (112), edge computing device 3 (113), and edge computing device 4 (114) are available to participate in edge computing and/or physical activities, based on digital twin simulations. System 100 uses digital twin simulations to predict that edge computing device 4 (114) will encounter a health issue such as mechanical or electronical problems. System 100 uses digital twin simulations to predict a certain time point (or an impact occurring time) when edge computing device 4 (114) is impacted by the health issue. Based on digital twin simulations, system 100 reduces the edge computing load edge computing device 4 (114) and reassign a certain amount of the edge computing load of edge computing device 4 (114) to edge computing device 1 (111), edge computing device 2 (112), and edge computing device 3 (113), so that edge computing device 4 (114) is able to complete the remaining (or not-reassigned) edge computing load by the time edge computing device 4 (114) is impacted by the health issue.

System 100 removes dependencies of edge computing device 1 (111), edge computing device 2 (112), and edge computing device 3 (113) on edge computing device 4 (114), when the remaining (or not-reassigned) edge computing load is completed by the time edge computing device 4 (114) is down or the impact occurring time is reached.

Based on digital twin simulations, system 100 determines whether one or more edge computing devices are needed to replace edge computing device 4 (114). If the one or more replacement edge computing devices are added, system 100 uses digital twin simulations to determine reassignment of edge computing loads among edge computing device 1 (111), edge computing device 2 (112), edge computing device 3 (113), and the one or more replacement edge computing devices. System 100 removes dependencies of edge computing device 1 (111), edge computing device 2 (112), and edge computing device 3 (113) on edge computing device 4 (114); furthermore, system 100 establishes dependencies among edge computing device 1 (111), edge computing device 2 (112), edge computing device 3 (113), and the one or more replacement edge computing devices.

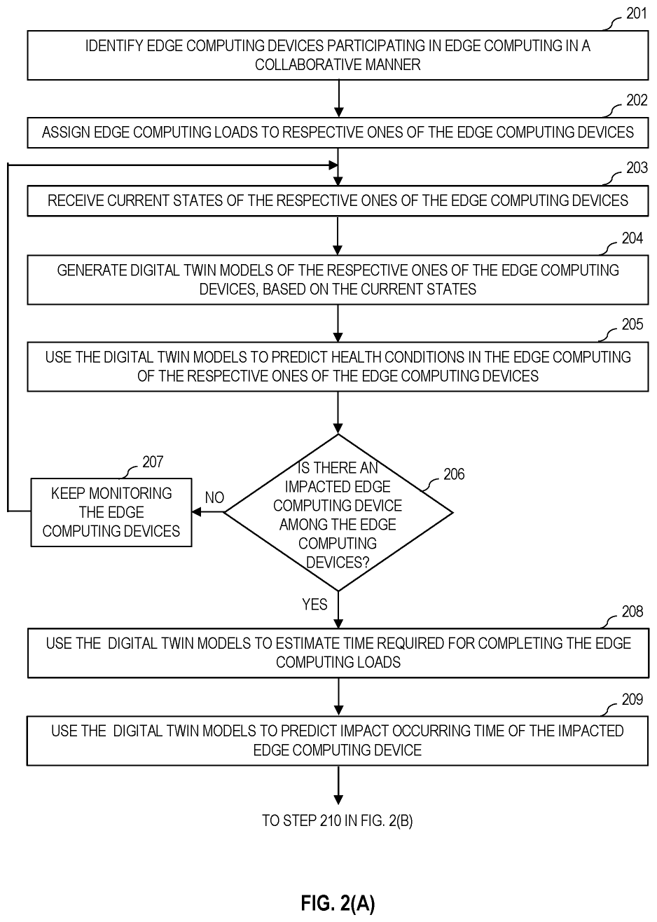

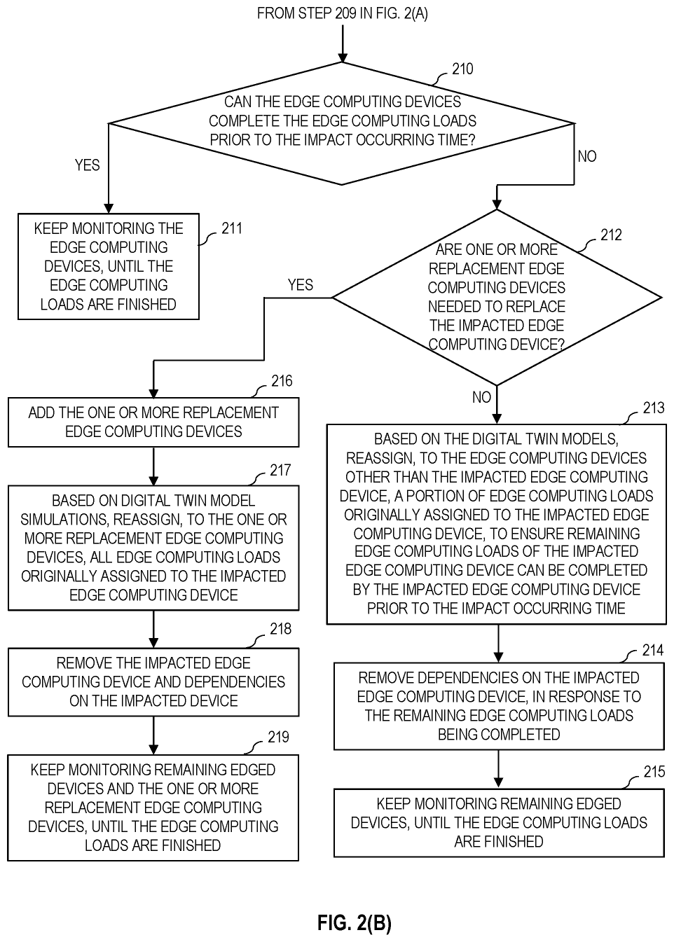

FIG. 2(A) and FIG. 2(B) present a flowchart showing operational steps of digital twin based data dependency integration in amelioration management of edge computing devices, in accordance with one embodiment of the present invention. The operational steps are implemented by system 100 (shown in FIG. 1) which is situated on a computer or server (such as computer 601 in FIG. 6).

Referring to FIG. 2(A), in step 201, the computer or server identifies edge computing devices participating in edge computing in a collaborative manner. While edge computing is in progress, the edge computing devices can also perform physical activities. The physical activities of the edge devices may be mobility of the edge devices, material removal, or any other activity. The computer or server also identifies whether mobility is required for the edge devices while performing the edge computing. In the example shown in FIG. 1, system 100 on the computer or server identifies edge computing device 1 (111), edge computing device 2 (112), edge computing device 3 (113), and edge computing device 4 (114). Edge computing device 1 (111), edge computing device 2 (112), edge computing device 3 (113), and edge computing device 4 (114) participate in edge computing in a collaborative manner.

In step 202, the computer or server assigns edge computing loads to respective ones of the edge computing devices. Different edge devices have different capabilities, such as processing and storage memory for edge computing. Therefore, different edge computing loads are assigned to different edge computing devices. In the example shown in FIG. 1, system 100 assigns different edge computing loads to edge computing device 1 (111), edge computing device 2 (112), edge computing device 3 (113), and edge computing device 4 (114).

In step 203, the computer or server receives current states of the respective ones of the edge computing devices. The edge computing devices share their current states with the computer or server and send the current states to the computer or server, in order for the computer or server to build digital twin models of the edge computing devices. In the example shown in FIG. 1, system 100 receives the current states of edge computing device 1 (111), edge computing device 2 (112), edge computing device 3 (113), and edge computing device 4 (114).

In step 204, the computer or server generates digital twin models of the respective ones of the edge computing devices, based on the current states received in step 203. In the example shown in FIG. 1, system 100 generates digital twin model 1 (121) for edge computing device 1 (111), digital twin model 2 (122) for edge computing device 2 (112), digital twin model 3 (123) for edge computing device 3 (113), and digital twin model 4 (124) for edge computing device 4 (114).

In step 205, the computer or server uses the digital twin models to predicts health conditions of the respective ones of the edge computing devices. For example, the health conditions of the respective ones of the edge computing devices may be related to mechanical health, electronic or electrical circuit health, and computing health of the edge computing devices. Different types of health conditions may have different impact; for example, an edge computing device with mechanical problem may not be able to move or may not be able to generate required force, and an edge computing device with an electronic/electrical problem may create health issues with its edge computing capability.

In step 206, the computer or server determines whether there is an impacted edge computing device among the edge computing devices. Based on digital twin simulation, the computer or server predicts whether any edge computing device is impacted by its health issue in edge computing. In the example shown in FIG. 1, based on simulation with digital twin model 1 (121), digital twin model 2 (122), digital twin model 3 (123), and digital twin model 4 (124), system 100 determines whether any one of edge computing device 1 (111), edge computing device 2 (112), edge computing device 3 (113), and edge computing device 4 (114) is impacted or has a health issue in edge computing.

In response to determining that there is no impacted edge computing device (NO branch of decision block), in step 207, the computer or server keeps monitoring the edge computing devices and reiterates step 203.

In response to determining that there is an impacted edge computing device (YES branch of decision block), in step 208, the computer or server uses the digital twin models to estimate time required for completing the edge computing loads assigned to the respective ones of the edge devices. In the example shown in FIG. 1, system 100 determines that edge computing device 4 (114) is the impacted edge computing device. Based on simulation with digital twin model 1 (121), digital twin model 2 (122), digital twin model 3 (123), and digital twin model 4 (124), system 100 determines when edge computing loads of edge computing device 1 (111), edge computing device 2 (112), edge computing device 3 (113), and edge computing device 4 (114) can be completed.

In step 209, the computer or server uses the digital twin models to predict impact occurring time of the impacted edge computing device. Base on simulation with the digital twin models, the computer or server predicts how long the impacted edge computing devices are able to participate in edge computing. In the example shown in FIG. 1, based on digital twin simulations, system 100 predicts the time at which edge computing device 4 (114) is impacted.

Referring to FIG. 2(B), in step 210, the computer or server determines whether the edge computing devices can complete the edge computing loads prior to the impact occurring time, based on simulations with digital twin models. Using the digital twin models, the computer or server predicts how long the edge computing devices keep the same health status. Base on simulations with the digital twin models, the computer or server predicts when the edge computing capacity of the impacted edge computing device is reduced or stopped.

In response to determining that the edge computing devices can complete the edge computing loads prior to the impact occurring time (YES branch of decision block 210), at step 211, the computer or server keeps monitoring the edge computing devices, until the edge computing loads are finished. In response to determining that the edge computing devices cannot complete the edge computing loads prior to the impact occurring time (NO branch of decision block 210), at step 212, the computer or server determines whether one or more replacement edge computing devices are needed to replace the impacted edge computing device, based on simulations with digital twin models.

In response to determining that one or more replacement edge computing devices are not needed to replace the impacted edge computing device (NO branch of decision block 212), in step 213, based on simulations with the digital twin models, the computer or server reassigns a portion of edge computing loads originally assigned to the impacted edge computing device; the portion of edge computing loads are reassigned to other edge computing devices (or the edge computing devices other than the impacted edge computing device). By the reassignment, the computer or server ensures remaining edge computing loads (which are not reassigned) of the impacted edge computing device can be completed by the impacted edge computing device prior to the impact occurring time. In the example shown in FIG. 1, system 100 reassigns a portion of edge computing loads originally assigned to edge computing device 4 (114) and keeps remaining edge computing loads on edge computing device 4 (114), so that edge computing device 4 (114) is able to complete the remaining edge computing loads prior to the impact occurring time (or before edge computing device 4 (114) is down). The portion of the edge computing loads originally assigned to edge computing device 4 (114) are reassigned to edge computing device 1 (111), edge computing device 2 (112), and edge computing device 3 (113).

In step 214, the computer or server removes dependencies on the impacted edge computing device, in response to the remaining edge computing loads being completed. The system or server identifies a appropriate timeline when the dependencies of other edge computing devices on the impacted edge computing device is to be removed. In the example shown in FIG. 1, system 100 removes the dependencies of edge computing device 1 (111), edge computing device 2 (112), and edge computing device 3 (113) on edge computing device 4 (114).

In step 215, the computer or server keeps monitoring remaining edged devices, until the edge computing loads are finished. In the example shown in FIG. 1, system 100 continue to monitor the remaining edged devices, including edge computing device 1 (111), edge computing device 2 (112), and edge computing device 3 (113).

In response to determining that one or more replacement edge computing devices are needed to replace the impacted edge computing device (YES branch of decision block 212), in step 216, the computer or server adds the one or more replacement edge computing devices the edge computing ecosystem. In step 217, based on digital twin model simulations, the computer or server reassigns all the edge computing loads originally assigned to the impacted edge computing device, and the computer or server may reassigns them to the one or more replacement edge computing devices. The computer or server may also assign some edge computing loads originally assigned to the impacted edge computing device to those edge computing devices that are remained in the edge computing ecosystem.

In step 218, the computer or server removes the impacted edge computing device and dependencies on the impacted edge computing device. New dependencies on the one or more replacement edge computing devices are established. In step 219, the computer or server keeps monitoring remaining edged devices (those are remained in the edge computing ecosystem after the impacted edge computing device is removed) and the one or more replacement edge computing devices, until the edge computing loads are finished.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In FIG. 3, computing environment 300 contains an example of an environment for the execution of at least some of the computer code involved in performing the inventive methods, such as program(s) 326 for performing digital twin based data dependency integration in amelioration management of edge computing devices. In addition to block 326, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 326, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”) These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 326 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface type operating systems that employ a kernel. The code included in block 326 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301), and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

What is claimed is:

1. A computer-implemented method for amelioration management of edge devices in edge computing, the method comprising:
generating digital twin models of respective ones of edge devices, based on current states of the respective ones of the edge devices;
using the digital twin models to predict an impacted edge device which has a health issue in edge computing;
using the digital twin models to predict impact occurring time;
based on simulations with the digital twin models, reassigning a portion of edge computing loads that originally assigned to the impacted edge device to the edge devices other than the impacted edge device;
keeping remaining edge computing loads on the impacted edge device such that the impacted edge device is able to complete the remaining edge computing loads prior to the impact occurring time; and
removing dependencies of the edge devices other than the impacted edge device on the impacted edge device, in response to the remaining edge computing loads being completed.

2. The computer-implemented method of claim 1, further comprising:
determining whether one or more replacement edge devices are needed to replace the impacted edge device.

3. The computer-implemented method of claim 2, further comprising:
in response to determining the one or more replacement edge devices being needed, adding the one or more replacement edge devices;
based on simulations with the digital twin models, reassigning all the edge computing loads that are originally assigned to the impacted edge device to the one or more replacement edge devices;
removing the impacted edge device from the edge computing and removing the dependencies on the impacted edge device; and
establishing dependencies on the one or more replacement edge devices.

4. The computer-implemented method of claim 1, further comprising:
identifying the edge devices participating the edge computing in a collaborating manner; and
assigning edge computing loads to the respective ones of the edge devices.

5. The computer-implemented method of claim 1, further comprising:
receiving, from the respective ones of the edge devices, the current states.

6. The computer-implemented method of claim 1, further comprising:
using the digital twin models to estimate time required for completing edge computing loads assigned to the respective ones of the edge devices.

7. The computer-implemented method of claim 1, further comprising:
using the digital twin models to predict health conditions in the edge computing of the respective ones of the edge devices.

8. A computer program product for amelioration management of edge computing devices in edge computing, the computer program product comprising a computer readable storage medium having program instructions stored therewith, the program instructions executable by one or more processors, the program instructions executable to:
generate digital twin models of respective ones of edge devices, based on current states of the respective ones of the edge devices;
use the digital twin models to predict an impacted edge device which has a health issue in edge computing;
use the digital twin models to predict impact occurring time;
based on simulations with the digital twin models, reassign a portion of edge computing loads that originally assigned to the impacted edge device to the edge devices other than the impacted edge device;
keep remaining edge computing loads on the impacted edge device such that the impacted edge device is able to complete the remaining edge computing loads prior to the impact occurring time; and
remove dependencies of the edge devices other than the impacted edge device on the impacted edge device, in response to the remaining edge computing loads being completed.

9. The computer program product of claim 8, further comprising the program instructions stored on the computer readable storage medium, the program instructions executable to:
determine whether one or more replacement edge devices are needed to replace the impacted edge device.

10. The computer program product of claim 9, further comprising the program instructions stored on the computer readable storage medium, the program instructions executable to:
in response to determining the one or more replacement edge devices being needed, add the one or more replacement edge devices;
based on simulations with the digital twin models, reassign all the edge computing loads that are originally assigned to the impacted edge device to the one or more replacement edge devices;
remove the impacted edge device from the edge computing and remove the dependencies on the impacted edge device; and
establish dependencies on the one or more replacement edge devices.

11. The computer program product of claim 8, further comprising the program instructions stored on the computer readable storage medium, the program instructions executable to:
identify the edge devices participating the edge computing in a collaborating manner; and
assign edge computing loads to the respective ones of the edge devices.

12. The computer program product of claim 8, further comprising the program instructions stored on the computer readable storage medium, the program instructions executable to:
receive, from the respective ones of the edge devices, the current states.

13. The computer program product of claim 8, further comprising the program instructions stored on the computer readable storage medium, the program instructions executable to:
use the digital twin models to estimate time required for completing edge computing loads assigned to the respective ones of the edge devices.

14. The computer program product of claim 8, further comprising the program instructions stored on the computer readable storage medium, the program instructions executable to:
use the digital twin models to predict health conditions in the edge computing of the respective ones of the edge devices.

15. A computer system for amelioration management of edge computing devices in edge computing, the computer system comprising one or more processors, one or more computer readable tangible storage devices, and program instructions stored on at least one of the one or more computer readable tangible storage devices for execution by at least one of the one or more processors, the program instructions executable to:
generate digital twin models of respective ones of edge devices, based on current states of the respective ones of the edge devices;
use the digital twin models to predict an impacted edge device which has a health issue in edge computing;
use the digital twin models to predict impact occurring time;
based on simulations with the digital twin models, reassign a portion of edge computing loads that originally assigned to the impacted edge device to the edge devices other than the impacted edge device;
keep remaining edge computing loads on the impacted edge device such that the impacted edge device is able to complete the remaining edge computing loads prior to the impact occurring time; and
remove dependencies of the edge devices other than the impacted edge device on the impacted edge device, in response to the remaining edge computing loads being completed.

16. The computer system of claim 15, further comprising the program instructions stored on the at least one of the one or more computer readable tangible storage devices, the program instruction executable to:
determine whether one or more replacement edge devices are needed to replace the impacted edge device;
in response to determining the one or more replacement edge devices being needed, add the one or more replacement edge devices;
based on simulations with the digital twin models, reassign all the edge computing loads that are originally assigned to the impacted edge device to the one or more replacement edge devices;
remove the impacted edge device from the edge computing and remove the dependencies on the impacted edge device; and
establish dependencies on the one or more replacement edge devices.

17. The computer system of claim 15, further comprising the program instructions stored on the at least one of the one or more computer readable tangible storage devices, the program instruction executable to:
identify the edge devices participating the edge computing in a collaborating manner; and
assign edge computing loads to the respective ones of the edge devices.

18. The computer system of claim 15, further comprising the program instructions stored on the at least one of the one or more computer readable tangible storage devices, the program instruction executable to:
receive, from the respective ones of the edge devices, the current states.

19. The computer system of claim 15, further comprising the program instructions stored on the at least one of the one or more computer readable tangible storage devices, the program instruction executable to:
use the digital twin models to estimate time required for completing edge computing loads assigned to the respective ones of the edge devices.

20. The computer system of claim 15, further comprising the program instructions stored on the at least one of the one or more computer readable tangible storage devices, the program instruction executable to:
use the digital twin models to predict health conditions in the edge computing of the respective ones of the edge devices.
